(19) United States
(12) Patent Application Publication
(10) Pub. No.: US 2007/0099746 A1
(43) Pub. Date: May 3, 2007

(54) Self aligning gear set

(75) Inventor: Ed Hahlbeck, Waukeska, WI (US)

Correspondence Address: BARNES & THORNBURG LLP, P.O. BOX 2786, CHICAGO, IL, 60690-2786, US

(73) Assignee: Gardner Denver, Inc.

(21) Appl. No.: 11/314,792

(22) Filed: Dec. 21, 2005

Related U.S. Application Data
(60) Provisional application No. 60/732,338, filed on Oct. 31, 2005.

(51) Int. Cl. F16H 57/08

(52) U.S. Cl. 475/331

(57) ABSTRACT

A self-aligning gear set for maintaining optimal meshing contact between a driving gear and a driven gear that compensates for shaft deflection under a range of loads and when an industrial double helical gear set that has a pair of helical shaft gears meshing with a pair of helical flexible bull gears and when the gear set is operating under a load the shaft gears have their axial force vectors directed away from the shaft ends and the flexible helical bull gears have their axial force vectors directed toward each other such that the shaft and bull gears remain in substantial alignment during load operation of the gear set. The bull gears preferably have a hub; an annular web positioned about said hub; and a ring gear replaceably attached to the outer circumference of said annular web.

### RELATED APPLICATIONS

This application claims the benefit of U.S. Provisional Patent Application Ser. No. 60/732,338 filed Oct. 31, 2005.

### FIELD OF INVENTION

This invention relates to a self-aligning double gear set that has a pinion shaft, or drive shaft, and a pair of drive shaft gears and a second pair of gears that adjust themselves the shaft deflection that occurs under an operating load.

### BACKGROUND

Stimulation pumps are used extensively in well drilling operations and are relatively lightweight pumps that operate at high pressures. Stimulation pumps circulate drilling fluid, typically mud, under high pressure. The pressurized fluid enters voids in underlying rock and forces the voids apart aiding in drilling operations. The fluid also forces rock chips to the surface of the well to remove them from the bore and also cools the drill bit.

Stimulation pumps are frequently driven on opposing ends of the crankshaft by bull gears engaged to a common pinion shaft, or drive shaft. This is an economical arrangement in that power to a single input shaft provides a dual power path allowing smaller gears. Helical gears are used to increase gear power capacity and for smooth operation. Such a double helical gear set is shown U.S. Pat. No. 4,512,694.

Power levels in stimulation pumps have increased from the original design of 600 HP to 2,500 HP for the same basic design. As the power and torque increase, the driving gear set requires better materials, heat treatment and quality. As these parameters reach their physical limits, the capacity of the gears also reach their limit.

Gear teeth are very sensitive to the alignment of mating tooth surfaces in the load transmission path. Errors of even a few microns influence gear capacity and life. In this particular application, a long slender jack shaft-pinion drives two light-weight gears. The pinions and gears are mounted in an overhung arrangement. While more robust configurations of bearing mounting are possible, these other configurations would add significant cost and complexity. An overhung mounting arrangement is very satisfactory and cost efficient, except for the problem of maintaining good tooth alignment.

Traditionally, the bull gears used in stimulation pumps have utilized web reinforced gears and teeth crowned to accommodate severe deflections. These deflections are due to significant bending of the pinion shaft, which is much greater than the stiffened gears. The helical teeth cause additional misalignment by deflecting away from the mesh due to gear tooth thrust forces. These deflections cause tooth surface misalignment resulting in higher stresses and reduced gear life. In this disclosure, the bull gear is designed with a more flexible body and gear tooth direction (hand) is reversed to reverse the direction of the thrust forces on the bull gears.

The use of crowned or tapered gear teeth can improve the tooth alignment for a given load. The tooth modifications are optimal for a specific load and its resulting deflection. For all other loads the modification is non-optimal, resulting in increasing stress and reduced life.

The traditional design process has been to accept the inevitable deflections of the pinion and to compensate for this by crowning the teeth in one or both of the pinion and the gear. Crowning avoids undesirable end loading, however, crowning sufficient to relieve undesirable end loading also reduces the even distribution across the gear face. The increased local loading increases stress and limits power capacity and gear life.

By selecting proper helix direction, and adjusting the gear body stiffness, the gear deflects in unison with, and opposite direction, of the mating pinion. This results in continuous and optimal alignment of the gear tooth surfaces at all loads. By providing continuous and optimal alignment of the gear tooth surfaces at all loads, small crowns may be used on the teeth, resulting in lower stresses. This reduction in stress increases fatigue life and service life by several orders of magnitude.

The optimized gear body design does not add material or labor costs and provides an economic benefit. The reduction in gear stress increases gear life substantially by several orders of magnitude, thus providing additional benefits.

### SUMMARY

My invention eliminates some of the problems associated with the use of industrial double helical gear sets by providing a self-aligning gear set to adjust to pinion shaft deflection that occurs under an operating load. By adjusting to the pinion shaft deflection, optimal alignment is maintained across a range of loads and surface misalignment of mating gear teeth is minimized, reducing wear and extending life of the gear. The present disclosure provides a self-aligning gear set that accommodates pinion shaft deflection under load.

In the present invention, the bull gear is designed with a flexible body and the gear tooth direction (hand) is selected so as to direct thrust forces in a direction favoring gear alignment.

One feature of the present invention provides a double gear set having a drive shaft having a first drive shaft gear at or near one end thereof and a second drive shaft gear at or near the other end thereof. The first and second drive shaft gears are preferably helical having meshed axial force vectors directed away from each other and outward from the drive shaft. A third bull gear, preferably helical, is adapted to mesh with the first drive shaft gear and a fourth bull gear preferably helical is adapted to mesh with the second drive shaft gear with the third gear having a third meshed gear axial force vector directed toward the fourth gear, and the fourth gear having a fourth meshed gear axial force vector directed toward the third gear axial force vector and toward the third gear.

Another feature of my invention is my above described industrial gear set wherein the drive shaft tend to bend under some loads and the first and forth gears are flexible gears that bend with the drive shaft to substantially maintain alignment of the first and second gears with the third and fourth gears when they are in driven engagement.

Another feature of my invention is a self-aligning gear set having a first gear preferably helical, mounted to a first shaft with the first shaft having a deflection when the gear set is coupled to a load and a flexible second gear, preferably helical, meshing with the first gear, wherein the flexible second gear deflects under the load maintaining alignment between the first gear and the second gear.

Still another feature of my invention is my above described gear set wherein the flexible second gear has a hub; an annular web positioned about the hub; and a ring gear removably attached to the outer circumference of the annular web.

Still another feature of my invention is a self-aligning gear set having a pinion shaft having a first and second ends; a first pinion gear fixed to the first end of the pinion shaft and a second pinion gear fixed to the second end of the pinion shaft; a crankshaft having a first and second end; a first flexible gear fixed to the first end of the crankshaft and a second flexible gear fixed to the second end of the crankshaft; the first pinion gear is in meshing alignment with the first flexible gear and the second pinion gear is in meshing alignment with the second flexible gear; the said pinion shaft has a deflection when subjected to a load, wherein the first and second flexible gears are deflected such that alignment is maintained between the first pinion and the first flexible gear and the second pinion and the second flexible gear.

Still another feature of my invention is a self-aligning gear set for maintaining optimal meshing contact between a driving gear and a driven gear that compensates for shaft deflection under a range of loads and when an industrial double helical gear set that has a pair of helical shaft gears meshing with a pair of helical flexible bull gears and when the gear set is operating under a load the shaft gears have their axial force vectors directed away from the shaft ends and the flexible helical bull gears have their axial force vectors directed toward each other such that the shaft and bull gears remain in substantial alignment during load operation of the gear set.

### BRIEF DESCRIPTION OF THE DRAWINGS

FIG. 1 is a perspective view of a model showing the general arrangement of the gears of the present disclosure;

FIG. 2 is a front view of a schematic representation of the gear drive arrangement of FIG. 1;

FIG. 3 is a side view of a schematic representation of the gear drive arrangement FIG. 1;

FIG. 4 is a detailed view showing an optimized gear body deflection for one of the bull gears shown in FIG. 1;

FIG. 5 shows forces on a traditional gear set in an unloaded state;

FIG. 6 shows forces and deflection on a traditional gear set in a loaded state;

FIG. 7 shows forces and deflections on a gear set of the present disclosure;

FIG. 8 is a plot of the stresses in the stresses in a misaligned gear tooth without crowning;

FIG. 9 is a plot of stresses across the face of a gear tooth with crowning to compensate for the misalignment;

FIGS. 10 is a plot of the surface stresses across the face of a gear of the present disclosure:

FIG. 11 is a plot of the load distribution across the face of a gear of the present invention;

FIG. 12 is a plot showing the deflections of a gear set of the present invention;

FIG. 13 shows the general arrangement of a typical bull gear with a removably attached ring gear;

FIG. 14 details the removably attached ring gear of FIG. 13;

FIG. 15 is a detailed view of the pinion shaft of an embodiment of the present disclosure.

### DETAILED DESCRIPTION

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the disclosure as expressed by the following numbered features and elements.

Referring to FIG. 1, a gear set 10 is commonly used to transmit power for driving stimulation pumps or other rotating machinery. A pinion shaft 12 is connected to a driver, such as an electric motor, turbine, or other rotary device, for driving stimulation pumps or other machinery. The pinion shaft 12 is supported in an over-hung fashion by bearings 14, which are located inboard of a first and second drive gear 16, 18 respectively. First and second drive gears 16, 18 mesh with first and second bull gears 20, 22 respectively. First and second bull gears 20, 22 are mounted on and drive a crankshaft 24 which is supported by bearings 26. Crankshaft 24 then drives the stimulation pump or other device.

The drive gears 16, 18 and the bull gears 20, 22 of the present disclosure are helical gears having teeth cut at an angle across the gear face as is generally known in the art. Because the teeth are cut at an angle, thrust forces are created by the meshing teeth.

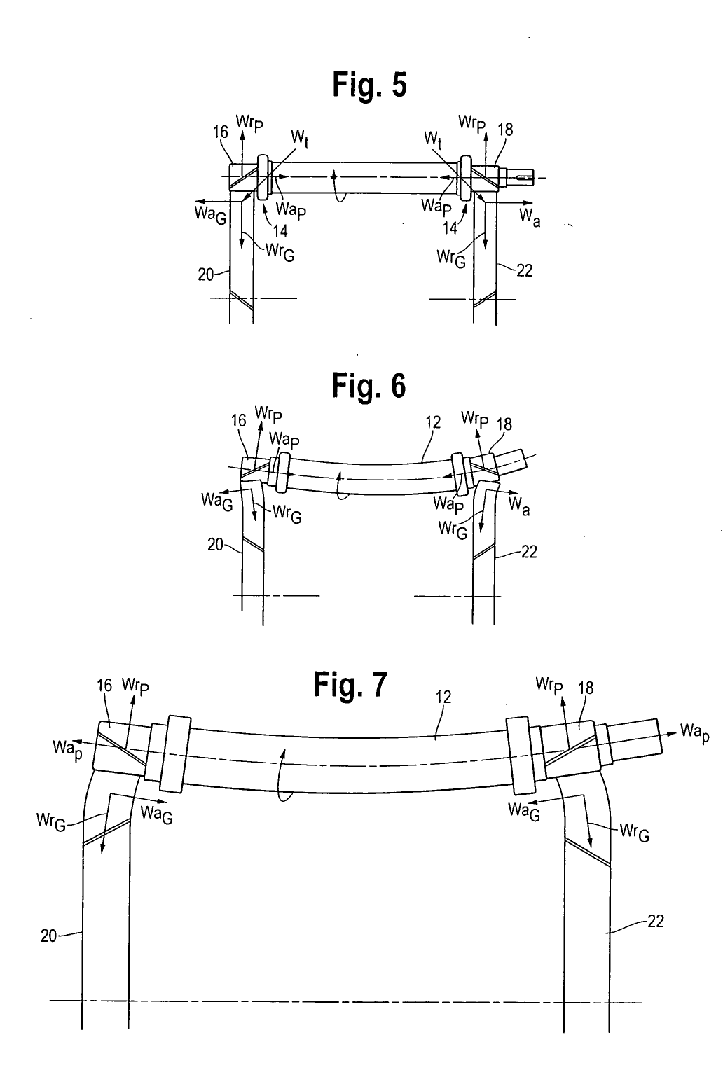

In a traditional gear set, the thrust forces wₜ₁ and wₜ₂ from the meshing of the helical gears can be resolved into their constituent force vectors as shown in FIGS. 5 and 6 for the given rotation of the pinion shaft 12.

As shown in FIG. 5, wₜ₁ is the thrust force vector on the right bull gear 22 which can be resolved into an outward force vector Wₐ and a downward force vector Wᵣ.

The term outward force vector means that the force on the bull gears adjacent their connection to the helical drive gears, are directed away from each other as is evident in FIGS. 5 and 6.

The helical pinion gear 16 has an upward force vector wᵣₚ direct away from the bull gear 20 and an inward force vector wₐₚ₁ directed toward the pinion gear 18. The helical pinion gear 18 has an inward force vector Wₐₚ₂ directed toward the pinion gear 16 and an upward force vector wᵣₚ directed away from the bull gear 22.

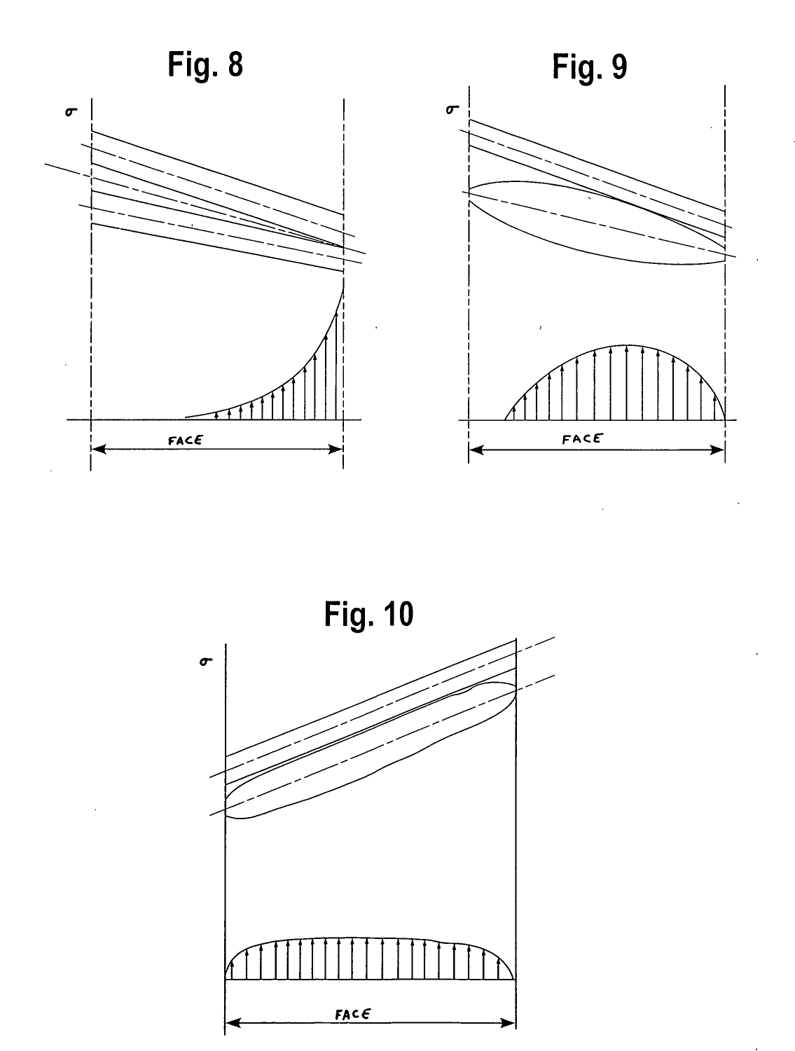

Thus, when the traditional gear set as shown in FIG. 5 is placed under load, these thrust forces cause bending of the pinion shaft 12 and of the bull gears 20, 22 as shown in FIG. 6. Such bending causes the meshing gear tooth surfaces to become misaligned, resulting in higher stresses and reduced gear life. FIG. 8 shows the gear tooth surface stress distribution created in a traditional gear set, wherein σ is the stress in the tooth, which is greatest at the leading edge of the tooth face. Traditional methods for improving gear tooth alignment under load use tapered or crowned gear teeth. FIG. 9 shows that by crowning the gear tooth, the surface stress is more evenly distributed across the face of the tooth, yet still has a peak which is located towards the center of the tooth face. However, tapering or crowning the gear teeth is an optimal solution only at a specific load with its resulting deflection. For most other loads the crowning is non-optimal and results in increasing stress and reducing the life of the gears. The gears set of the present disclosure provides a solution that is optimal across a range of loads and deflections, thus reducing stresses and improving gear life.

This is accomplished by constructing the pinion gears 16, 18 and bull gears 20,22 as shown in FIG. 7 such that the force vector wₐₚ on drive gear 18 is an outward force vector which directed away from bull gear 22. The drive gear 18 is constructed so that the force vector Wᵣₚ₁ thereof is an outward force vector which is directed away from bull gear 20. The bull gear 20 is constructed so that the force vector w_{ag} is an inward force vector and is directed toward bull gear 22. The bull gear 22 is constructed so that the force vector w_{ag} is an inward force vector that is directed toward bull gear 20. Thus as shown in FIG. 7. The reversing of the thrust vector in drive gears and the bull gears 20, 22 creates a deflection in the bull gears 20, 22 that matches the deflection in the pinion shaft 12 across a range of loads.

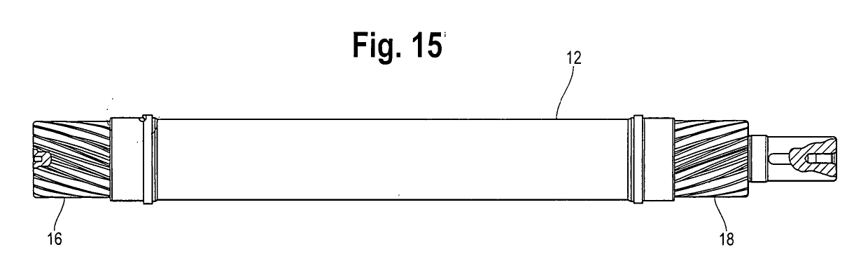

Referring to FIG. 15, the pinion shaft 12 of the present disclosure has pinion gears 16, 18 integrally machined into the pinion shaft 12. It should be apparent to one skilled in the art that pinion gears 16, 18 mounted on pinion shaft 12 and secured by a keyway, interference fit, or other means known in the art is equally acceptable.

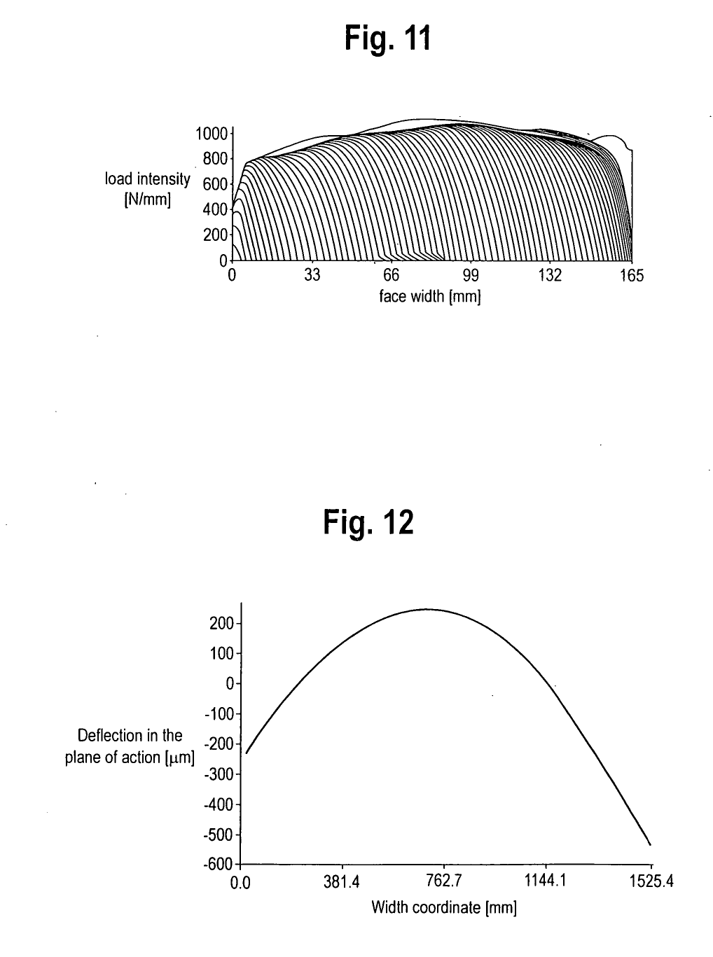

FIG. 10 shows the surface stress distribution across a gear tooth of the present disclosure. As should be noted, not only is the stress distributed across substantially the entire gear face, the magnitude of the peak stress level is also reduced.

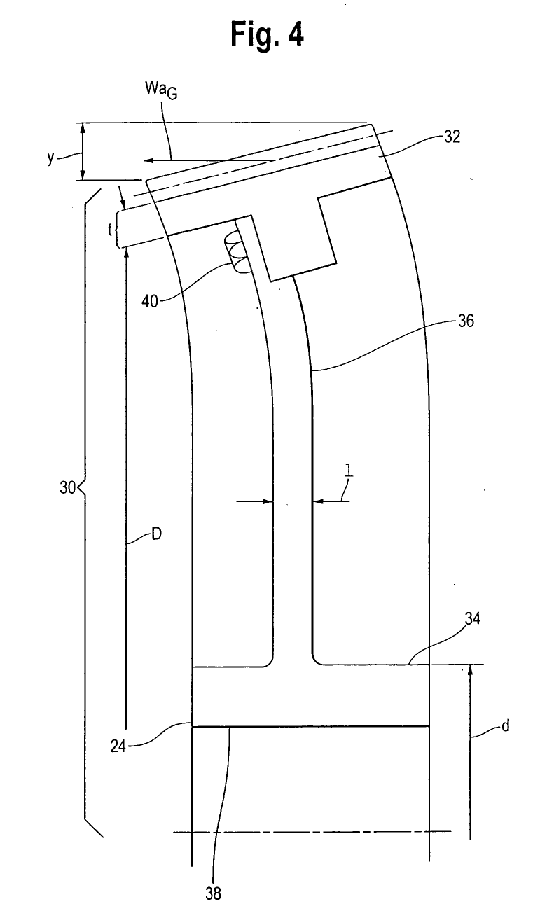

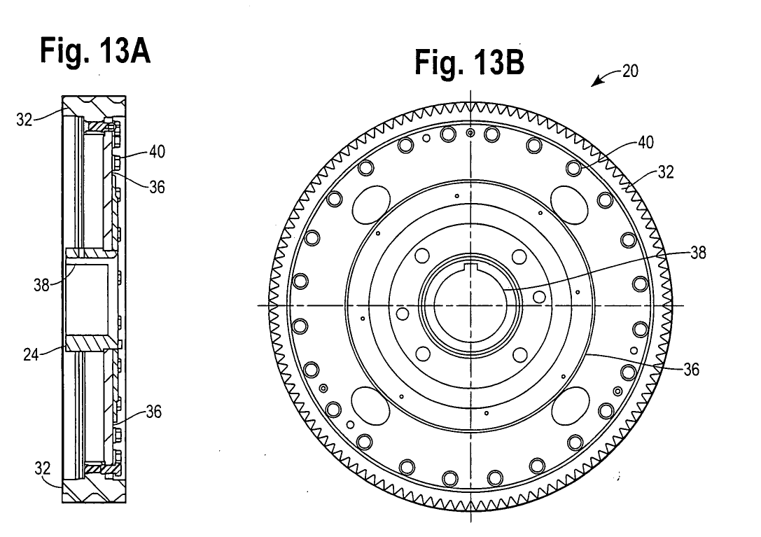

Referring now to FIG. 4, which shows a representative half of bull gear 22, which is a web-reinforced type gear as is generally known in the art, designed with a flexible body 30 and a bolt-on ring gear 32. FIG. 13 shows the general arrangement for a typical bolt on ring gear arrangement. This feature provides flexibility in design because hubs and ring gears may be interchanged and combined to provide optimal gear sets across a variety of pump applications with a minimal number of parts. This arrangement also allows for replacement of worn gear teeth by simply replacing the removably attached ring gear instead of having to replace the entire bull gear. Bull gear 20 would have a similar construction except it would bend to the right, as shown in FIG. 7, instead of to the left as shown in FIG. 4.

Flexible body 30 has a hub 34 with an annular web 36 extending therefrom. An aperture 38 is provided for mounting the gear body 30 the crankshaft 24. A helically cut ring gear 32 is removably attached to the outer circumference of web 36 by bolts 40 or by other suitable means known in the art.

The gear body 30 is designed by combining the thrust vector with material dimensions so as to attain a spring rate of the deflection y that exactly compensates for the pinion shaft deflection as shown in FIG. 4. Wherein d is the distance from the center of the hub 34 to its outer surface, D is the distance from the inside diameter of the hub 34 to the inside diameter of the ring gear 32; l is the thickness of the web 36; and t is the thickness of the ring gear 32 as shown in FIG. 4. Dimensions D and l are chosen so that when the gear set is loaded, force w_{ag} creates a bending moment that deflects gear body 30 that compensates for the deflection of the pinion shaft 12 such that the face of the ring gear 32 and the face of its mating pinion gear 16 or 18 remain aligned. Because of the gear body is flexible, the larger the force w_{ag}, the more the deflection y of the gear body. As load increases, the deflection of the gear body increases thus maintaining an optimum alignment across a range of loadings.

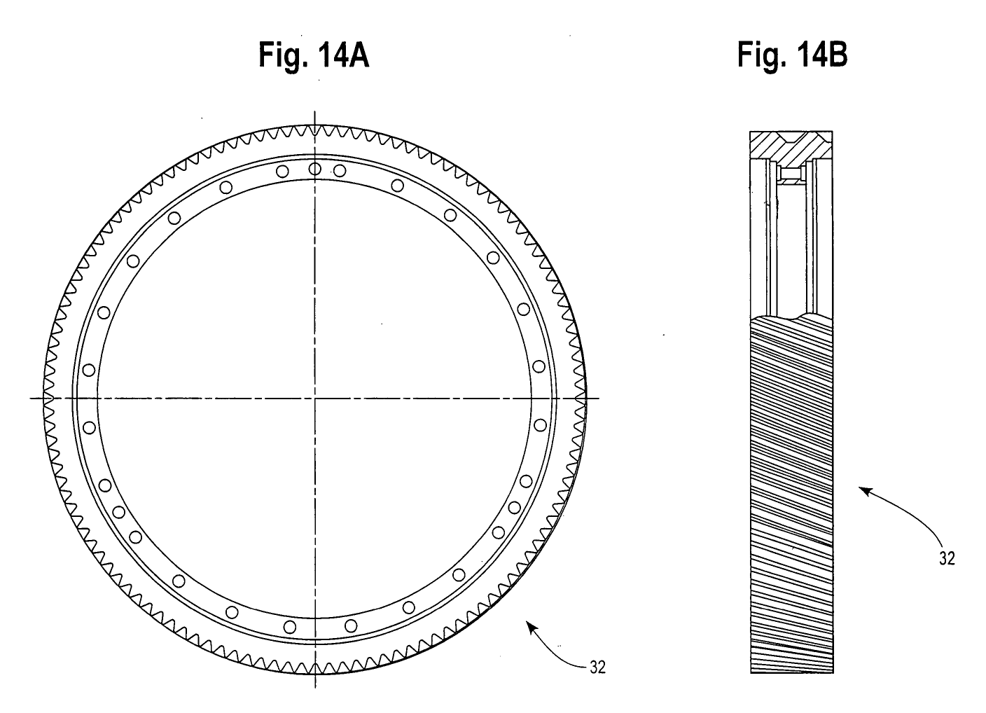

For example, The bull gear shown in FIG. 13 has a hub, a flexible annular web positioned about the hub, and a replaceable ring gear removably attached to the outer circumference of the annular web. The ring gear used for one embodiment, as shown in FIG. 14, has an outer diameter of 39 inches and preferably has 95 to 118 helical gear teeth and has at least removable pins that are equally spaced from each other (i.e. 120°) and a plurality of hex bolts that attached the ring gear to the outer end of the web.

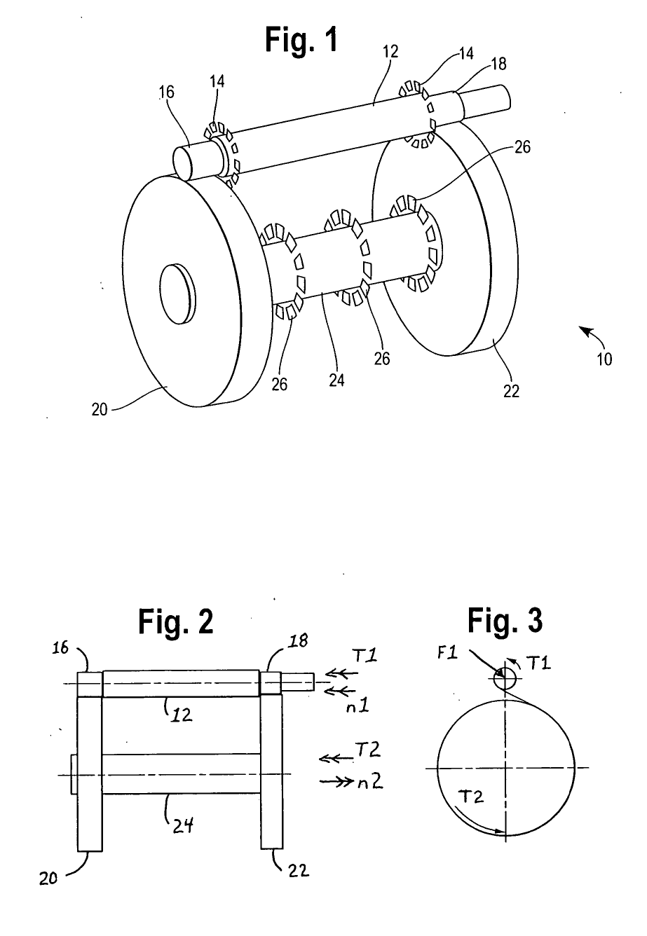

Computer modeling of the gear set allows for optimizing gear body deflection and gear tooth stress. The model for such a simulation is shown in FIGS. 1 through 3, wherein T1 is the torque of the drive gear 16, T2 is the torque of the bull gear 20. The computer simulation resolves the strength and spring rates of the gear elements and their support system. When the system is optimized, the tooth crowning is reduced and tailored to the compensating motion of the gear and pinion. Since both the pinion and gear deflection are linear to load, the mating tooth surfaces remain aligned at all load levels.

FIGS. 11 and 12 show the reduced stress provided by the gear arrangement of the present invention.

While this invention has been illustrated and described in the preceding disclosure, it is recognized that variations and changes may be made, therein, without departing from the invention as set forth in the claims.

What is claimed is,

1. A double gear set comprising:
a drive shaft having a first drive shaft gear at or near one end thereof and a second drive shaft gear at or near the other end thereof;
said first and second drive shaft gears having meshed axial force vectors directed away from each other and outward from said drive shaft;
a third bull gear adapted to mesh with said first drive shaft gear;
a fourth gear adapted to mesh with said second drive shaft gear,
said third gear having a third meshed gear axial force vector directed toward said fourth gear, and
said fourth gear having a fourth meshed gear axial force vector directed toward said third gear axial force vector and toward said third gear.

2. The gear set of claim 1 which is an industrial gear set wherein the first, second, third and fourth gears are helical gears and the third and fourth gears each has a replaceable helical ring gear.

3. The industrial gear set of claim 2 wherein the drive shaft tend to bend under some loads and the first and forth gears are flexible gears that bend with said drive shaft to substantially maintain alignment of said first and second gears with said third and fourth gears when they are in driven engagement.

4. The industrial gear set of claim 2 wherein the third and fourth gears are bull helical gears.

5. A self-aligning gear set comprising:
a first and second gear mounted to a first shaft, said first shaft having a deflection when said gear set is coupled to a load;
a flexible third and fourth gear meshing respectively with said first and second gear, wherein said flexible third and fourth gears each deflects under said load maintaining alignment between said first, second, third and fourth gears.

6. The self-aligning gear set of claim 5 wherein said first and second gears and said flexible third and fourth gears have helical teeth and the flexible third and fourth gears each have a replaceable helical ring gear.

7. The self-aligning gear set of claim 6 wherein said flexible third and fourth gear each comprises:
a hub;
an annular web positioned about said hub; and
a ring gear replaceably attached to the outer circumference of said annular web.

8. A self-aligning gear set comprising:
a pinion shaft having first and second ends;
a first pinion gear fixed to said first end of the pinion shaft and a second pinion gear fixed to said second end of the pinion shaft;
a crankshaft having first and second ends;
a first flexible gear fixed to said first end of the crankshaft and a second flexible gear fixed to said second end of the crankshaft;
said first pinion gear in meshing alignment with said first flexible gear and said second pinion gear in meshing alignment with said second flexible gear;
said pinion shaft having a deflection when subjected to a load, wherein said first and second flexible gears are deflected such that alignment is maintained between said first pinion and said first flexible gear and said second pinion and said second flexible gear.

9. The self-aligning gear set of claim 8 wherein said flexible third and fourth gear each has a hub; an annular web positioned about said hub; and a ring gear replaceably attached to the outer circumference of said annular web.

10. A self-aligning industrial double helical gear set for maintaining optimal meshing contact between a driving gear and a driven gear that compensates for shaft deflection under a range of loads comprising:
a pair of helical shaft gears;
a pair of helical flexible bull gears meshing with said helical shaft gears;
said shaft gears having their axial force vectors directed away from the shaft ends and when the gear set is operating under a load; and
said flexible helical bull gears having their axial force vectors directed toward each other and when the gear set is operating under a load wherein the shaft and bull gears remain in substantial alignment during load operation of the gear set.

11. The self-aligning industrial double helical gear set of claim 10 wherein said flexible third and fourth gear each has a hub; an annular web positioned about said hub; and a ring gear replaceably attached to the outer circumference of said annular web.

12. A helical ring gear that is to be part of a self-aligning industrial double helical gear set comprising:
a plurality of gear teeth fixed to a flange; and
a plurality of apertures positioned about said flange for attaching said ring gear to a flexible gear body.
